(19) United States
(12) Patent Application Publication
(10) Pub. No.: US 2018/0269738 A1
(43) Pub. Date: Sep. 20, 2018

(54) MAGNET-BEARING ROTOR WITH A ONE-PIECE FRAME FOR A WHEEL MOTOR

(71) Applicant: LOHR ELECTROMECANIQUE, Hangenbieten (FR)

(72) Inventors: Daniel SCHEER, Still (FR); Pierre DUMAS, Strasbourg (FR); Laurent VERDIER, Eschau (FR)

(73) Assignee: LOHR ELECTROMECANIQUE, Hangenbieten (FR)

(21) Appl. No.: 15/762,664

(22) PCT Filed: Oct. 4, 2016
(86) PCT No.: PCT/FR2016/052541

§ 371 Date: Mar. 23, 2018

(30) Foreign Application Priority Data
Oct. 7, 2015 (FR) 1559529

(51) Int. Cl. H02K 1/30; H02K 1/04; H02K 1/27; H02K 7/00; H02K 15/03

(52) U.S. Cl. CPC H02K 1/30; H02K 1/04; H02K 15/03; H02K 7/006; H02K 1/2786

(57) ABSTRACT

The invention relates to a rotor including a one-piece metal frame having a cylindrical portion that is closed on one side by a closure portion forming a hub. Parallel axial rows of permanent magnets are mechanically and directly attached to the inner surface of the cylindrical portion of the frame by strips. The strips are preferably non-magnetic, and attached mechanically to the frame and arranged longitudinally between each row of magnets. The strips have a base that rests on the frame and the base is extended by flaring by two outwardly inclined sides. The inclined sides engage with inward inclined surfaces that have a complementary shape on the corresponding lateral edges of the adjacent magnets, such that the magnets are locked vertically and laterally.

### CROSS-REFERENCE TO RELATED APPLICATIONS

This application is a § 371 filing of PCT application PCT/FR2016/052541 filed on Oct. 4, 2016, which claims priority from French application FR 1559529 filed on Oct. 7, 2015. The disclosures of these applications are included by reference herein in their entirety.

### BACKGROUND

### Technical Field

The present invention relates to the general technical field of synchronous rotating machines with permanent magnets, machines for example of the motor or generator type, and more particularly to the technical field of wheel motors.

A preferential application of the invention is more specifically for an external rotor of a traction motor of the wheel motor type, for example a railway traction motor or for a road vehicle of any kind.

### PRIOR ART

Synchronous rotary machines with permanent magnets are conventionally composed of a moving part, called a rotor, including a series of permanent magnets of alternating polarity and a fixed part, called a stator, comprising a set of induction coils.

In order to generate the phenomenon of induction, which allows the setting in motion of the rotor in the case of a motor, or the generation of a current in the case of a generator, said rotor is a cylindrical portion upon which are assembled successive rows of permanent magnets, parallel therebetween and conventionally oriented according to the axial direction of the rotor, i.e., perpendicular to the rotation movement of said rotor.

Said magnets, which are intended to be arranged facing the stator coils, are of the same polarity within the same row, but are usually of alternating polarity from one row to the next. The implementation of alternating polarities can also be envisaged, with, for example, magnets of the same polarity arranged over two or three successive rows, and then magnets of the opposite polarity over the following two or three rows.

In a conventional manner, this type of rotor comprises a cylindrical metal frame, open at each of the ends thereof, to which the magnets are attached. This cylindrical frame is then closed at one of the ends thereof by a closure portion that is arranged on the frame, and then welded or screwed. At the central part thereof, said closure portion is advantageously manufactured in the form of a hub, making it possible to mount the rotor on an axis, an axle in the case of a wheel motor.

Thus, in traditional wheel motors, the cylindrical rotor frame and the part forming the hub are two separate pieces, inserted and connected to one another by welding or screwing. This two-part structure poses numerous problems.

In effect, when the closure portion is welded to the cylindrical rotor frame, the welding operation leads to deformation of the assembly which then requires re-machining of the obtained assembly after the welding thereof, in order to guarantee the geometric characteristics necessary for the proper functioning of the rotor (roundness). This deformation is even more significant if the permanent magnets are already assembled onto the rotor before performing the welding.

If the requirement is for the closure portion to be attached to the frame by screwing/bolting, it is necessary to provide the frame with a thick wall, such that the amount of material is sufficient in order to ensure solid attachment by means of screwing. Due to the greater amount of raw material used, the cost of the rotor is greater. Moreover, said greater wall thickness implies a reduction in the diameter of the inner free space of the rotor and therefore of the surface upon which the permanent magnets can be arranged. The magnetization surface is thus more restricted, leading to poorer overall performance of the wheel motor.

Finally, this structure, formed from two independent parts that are assembled together, is not completely rigid and the machining that is subsequently performed can result in distortions that alter the geometry of the rotor, which is no longer perfectly cylindrical, deformations that are problematic as regards the functioning of the rotating machine.

Moreover, in traditional rotors, the magnets are conventionally attached to the frame by means of bonding. However, because of the very significant forces that the magnets are subjected to during the operation of the rotor and the high temperatures reached within these machines, the adhesives used must be very efficient in order to guarantee satisfactory reliability, which is difficult to obtain. Ever more malfunctions are reported due to the current trend of wanting to manufacture more and more powerful synchronous machines whilst housing them within an increasingly reduced space, thus increasing the internal temperature. This desire for improved performance is difficult to reconcile with attaching the magnets by means of bonding.

In order to overcome the disadvantages of bonding, several alternative methods have been proposed in the prior art for the attachment of the magnets.

Thus, for example, the patent application EP 2.348.612 is known which discloses a synchronous machine rotor wherein each of the permanent magnets is bonded to an intermediate support member engaged within a groove of the frame, and is thus mechanically retained on the frame. The magnets disclosed have a surface that is less than that of the intermediate support members, in such a way as to leave a free space between adjacent magnets forming an air circulation channel between each row of magnets, thus limiting the general rise in temperature of the device.

Even though the creation of these channels allows for better air circulation, and thus some limitation as regards heating, it does not solve the problem of bonding the magnets. In effect, the magnets remain bonded to the intermediate support members and the adhesive used must be able to withstand the severe stresses that it is subjected to when operating, as explained previously.

In addition, due to the presence of these intermediate support members on the one hand and of the space left free for the air circulation channels on the other hand, the volume available to house the magnets is significantly reduced. All of this leads to a sharp decline in the performance of the rotor due to the small dimensions of the magnets used.

Also known is the patent application FR 3.002.378, also published under the number WO 2014/128410, that discloses a rotor whereupon the permanent magnets are retained by means of fastening strips that are engaged between the parallel rows of magnets and that are screwed to the frame. These fastening strips have a special shape with rounded sides, which is responsible for the relatively high cost for these strips. Furthermore, the permanent magnets that are associated with them must have a complementary rounded concave shape obtained by means of specific machining that is difficult to perform and which significantly increases the cost of these magnets.

In addition, even if the magnets are mechanically retained by these fastening strips, they must first be pre-bonded to the rotor frame prior to the introduction of the fastening strips. It is therefore not a fully mechanical fastening.

Moreover, the rotor described in this document is conventional. It comprises a cylindrical through-frame which is open at the two ends thereof that must subsequently be closed on one side by virtue of an inserted closure portion.

Also known are the devices disclosed in the patent applications WO 2014/199039 and EP 2.267.868 that describe a rotor wherein rows of permanent magnets are mechanically retained by means of ribs made within the thickness of the frame. Even though in this instance the retention is entirely mechanical, it requires complex and expensive machining of the cylindrical rotor frame in order to dig the receiving grooves of the rows of permanent magnets and in order to conform the ribs to the surface. This machining step is so expensive that in practice it is an obstacle to the manufacture and marketing of these solutions at an economically acceptable cost.

In addition, in order to be able to insert and drive the tools necessary to perform this machining, the rotor frame must mandatorily be provided in the form of a through-frame, i.e., open on both sides of the cylindrical portion thereof. Therefore, at one of the ends thereof, a closure portion must then be inserted that is separate from the frame and manufactured independently therefrom and which is fastened to the frame by screwing or welding with the aforementioned disadvantages.

The other documents mentioned also only refer to rotors wherein the cylindrical frame is open and traversing at each of the ends thereof.

### DESCRIPTION OF THE INVENTION

The object of the invention is to provide a rotor for a synchronous rotating machine which does not have the aforementioned disadvantages and wherein the cylindrical frame, serving as a support for the magnets, is manufactured as one-piece and integral with the closure portion forming a hub that closes one of the sides thereof.

The one-piece structure of the frame is particularly advantageous because it gives the assembly improved rigidity which guarantees much better stability of the geometric characteristics of the rotor in the event of subsequent machining and during use.

Another object of the invention is to provide a rotor wherein the permanent magnets are fastened onto the cylindrical portion of the frame by means of direct attachment, i.e., without an intermediate piece or mounting support, and entirely mechanically, i.e., without the need for any bonding or pre-bonding.

Given that the bonding of the magnets is replaced by completely mechanical fastening, perfect holding of these magnets is thus guaranteed whatever the internal temperature of the rotor during operation.

In addition, the means used for this fastening are perfectly compatible with the manufacture of a rotor with a one-piece frame including a one-piece cylindrical portion and closure portion forming a hub.

Finally, due to the extreme simplicity of the means used and the shape thereof, the solution taught by the invention is very economical, especially compared to the prior-art systems described.

In the present application, it will be convenient to understand the term “magnets” in the broad sense, i.e., on the one hand identifying elements manufactured using conventional magnetic materials and on the other hand elements manufactured using magnetizable materials. These magnetizable materials are for example manufactured using materials made of ferrite or alloys of the SmCo, AlNiCo or NdFeB type.

In order to solve these technical problems, the invention provides a magnet bearing rotor for a synchronous rotating machine with permanent magnets. It is a rotor in the general shape of a cylinder delimiting an inner receiving space wherein a fixed stator comprising a set of induction coils is intended to be arranged. Said rotor comprises a metal frame, a series of permanent magnets arranged in parallel rows oriented in the axial direction of the cylinder, and a set of fastening strips each placed longitudinally between two successive rows of permanent magnets and mechanically fastened to the frame.

According to the invention, the metal frame is a one-piece structure comprising two parts manufactured as one piece, namely: a cylindrical portion wherein the wall serves as a support for the permanent magnets and the fastening strips, and a closure portion forming a hub that closes one of the sides of the cylindrical portion.

Said fastening strips provide a direct mechanical attachment for permanent magnets on the inner surface of the wall of the cylindrical portion of the frame. They each comprise a base that rests on the inner surface of the wall of the cylindrical portion of the frame, and two outwardly inclined sides that extend said base by flaring it.

Said permanent magnets comprise, at each of the lateral edges thereof, a inward inclined surface of a complementary shape to that of the corresponding outwardly inclined side of the adjacent fastening strip, said inward inclined surface being engaged with said corresponding outwardly inclined side of the adjacent fastening strip, such that said fastening strips provide vertical and lateral locking of said permanent magnets

According to a preferred embodiment of the invention, the outwardly inclined sides of the fastening strips are extended by vertical or inward inclined flanges.

According to a preferred embodiment of the invention, the fastening strips have a cross-section of a hexagonal or trapezoidal shape.

According to one embodiment of the invention, the fastening strips are non-magnetic, or are less than half the height of the permanent magnets

According to one embodiment of the invention, the permanent magnets comprise at the lateral edges thereof, a vertical surface, or an outwardly inclined surface, or an outwardly curved surface that succeeds the inward inclined surfaces thereof.

According to one embodiment of the invention, the rotor has mechanical stops that ensure the longitudinal locking of the rows of permanent magnets.

According to a preferred variant of this embodiment, the mechanical stops are flanges, shoulders, or walls of the frame or even removable abutment parts.

According to another embodiment of the invention, the rotor can also comprise a layer of anti-corrosion resin.

Advantageously, the rotor according to the invention may be the rotor of a traction motor.

The invention also teaches about a wheel motor that comprises a rotor according to the invention presented above.

The invention also offers a method for the fastening of permanent magnets to a rotor according to the invention.

Said method comprises the following steps:
arranging the fastening strips on the inner surface of the wall of the cylindrical portion of the frame, parallel therebetween and according to the axial direction of the cylinder, spaced apart by a distance corresponding to the width of a row of permanent magnets, and pre-assembling said fastening strips by mechanical attachment onto the frame leaving a clearance between the fastening strips and the frame;
engaging magnetizable elements or permanent magnets between said fastening strips and sliding them longitudinally, taking advantage of the clearance between the fastening strips and the frame, in order to form parallel rows of magnetizable elements or permanent magnets;
completing the mechanical attachment of the fastening strips to the frame in order to remove the clearance between the fastening strips and the frame, and thus vertically and laterally locking the magnetizable elements or permanent magnets by engaging the inward inclined surfaces thereof with the outwardly inclined sides of the adjacent fastening strips; and
in the case where magnetizable elements are used, magnetizing these magnetizable elements such that they constitute permanent magnets.

### BRIEF DESCRIPTION OF THE FIGURES

Other features and advantages of the invention will become apparent upon reading the following detailed description, made with reference to the accompanying drawings, wherein:

FIG. 1 is a perspective front view of an example of a rotor according to the invention;

FIG. 2 is a perspective rear view of the rotor of FIG. 1;

FIG. 3 is an exploded perspective view of the various components of the rotor of FIG. 1 shown in the dissociated state;

FIG. 4 is a longitudinal cross-section view of the rotor of FIG. 1;

FIG. 5 is a transversal cross-section view of a portion of the rotor of FIG. 1;

FIG. 6 is an enlargement of the detail encircled in FIG. 5;

FIGS. 7 and 8 are perspective and transversal cross-section views, respectively, of an example of a fastening strip according to the invention shown in isolation;

FIGS. 9 and 10 are perspective and transversal cross-section views, respectively, of an example of a magnet according to the invention shown in isolation.

### DETAILED DISCLOSURE OF THE INVENTION

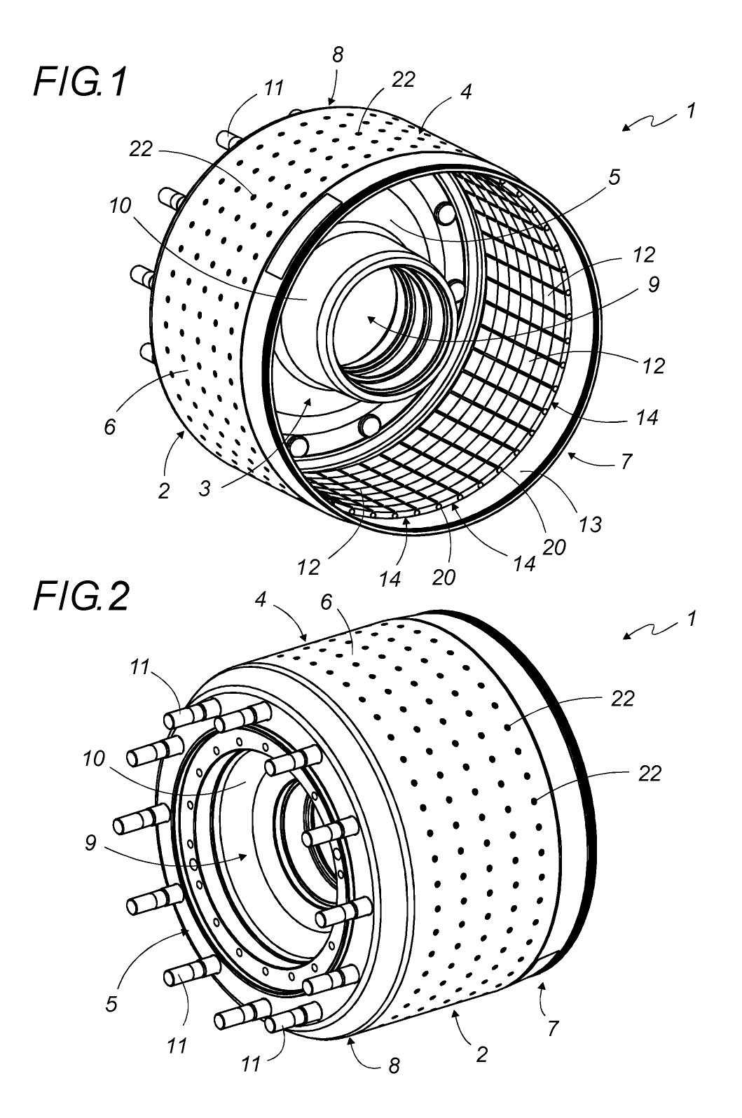

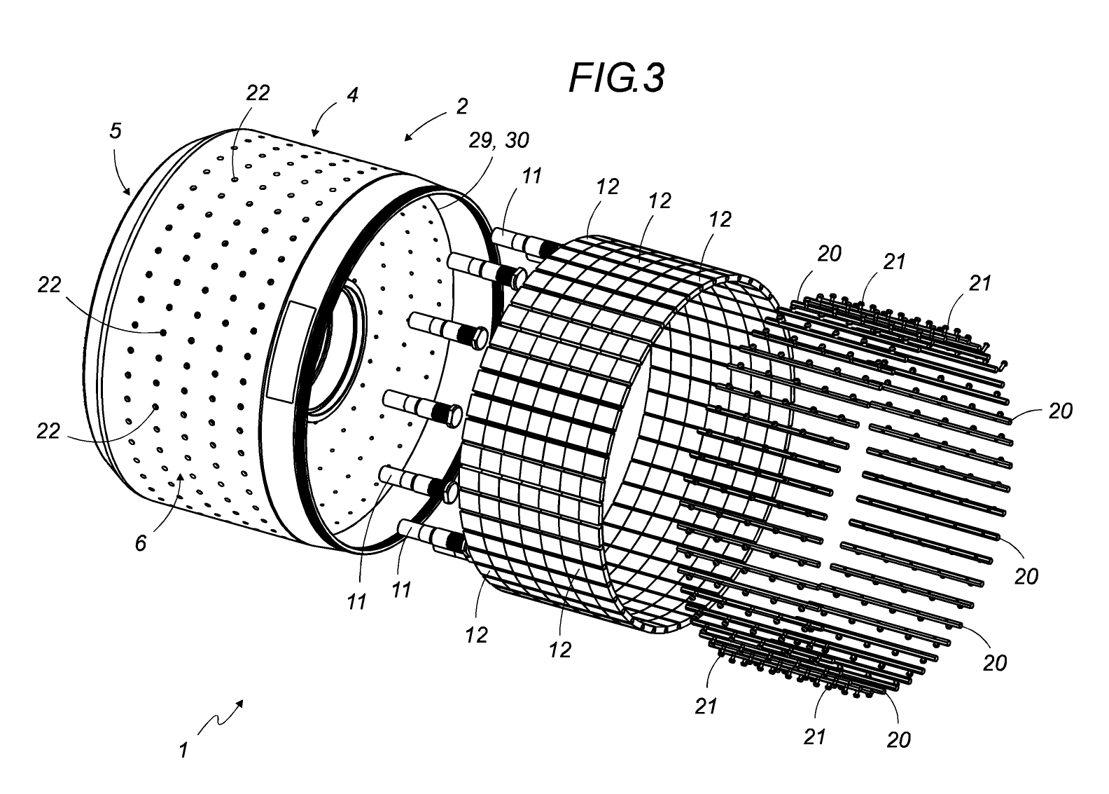

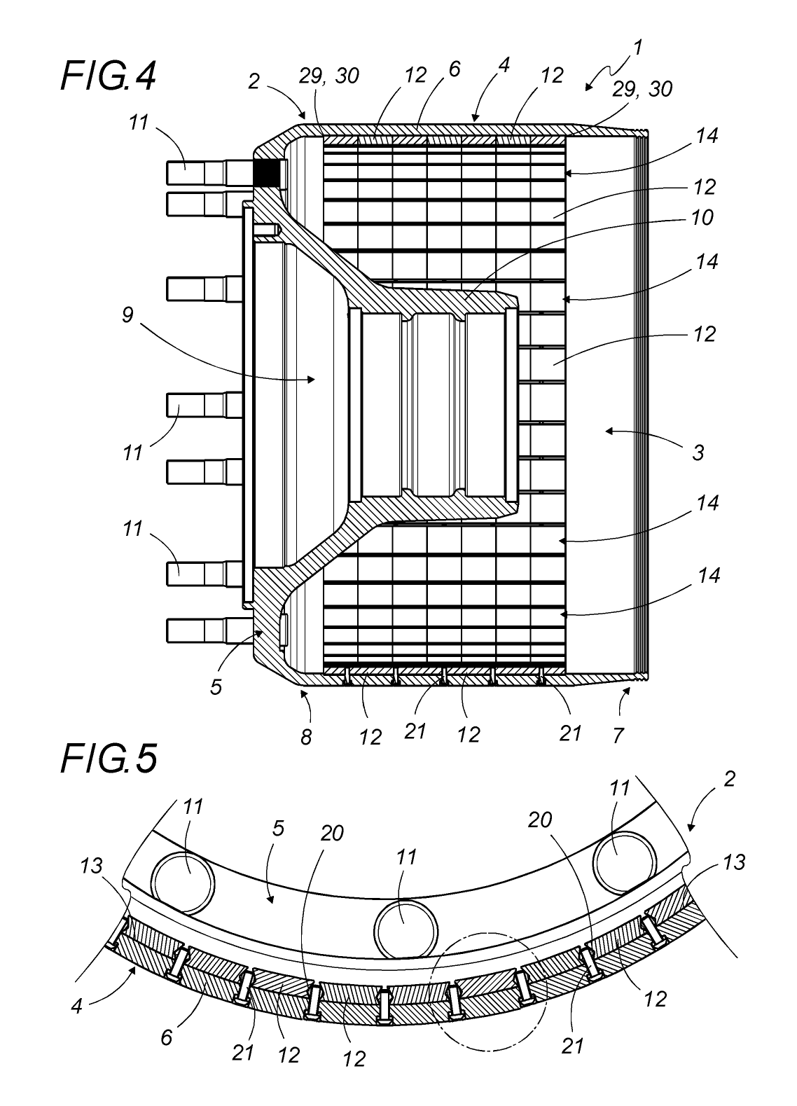

The present invention will now be described in detail with reference to FIGS. 1 to 10. Equivalent elements shown in different figures will bear the same reference numbers.

In these figures, a preferred embodiment of a rotor 1 according to the invention is illustrated. Of course, this is only one particular embodiment; a person skilled in the art could imagine and implement without difficulty many variations or modifications to this rotor without going beyond the scope of the invention defined within the appended claims.

The illustrated rotor 1 is a so-called “external” rotor which comprises a frame 2, preferably metal, of a generally cylindrical shape which, within the hollow interior thereof, delimits a receiving space 3 provided in order to accommodate a stator with induction coils (not shown).

The frame 2 is a monobloc structure manufactured integrally and as one piece, in a foundry for example. This one-piece structure comprises two integral parts, namely a cylindrical portion 4 and a closure portion 5.

The cylindrical portion 4 comprises a cylindrical wall 6 bordering the receiving space 3, and is open at one of the ends 7 thereof thus allowing full access to the receiving space 3 for the mounting of the stator.

The cylindrical portion 4 is closed at the other end 8 thereof by the closure portion 5 that extends as one piece the cylindrical wall 6.

Within the central portion thereof, the closure portion 5 has an opening 9 preferentially bordered by a return wall 10, substantially cylindrical and extending toward the inside of the cylindrical part 4 of the frame 2 in a concentric manner

Said return wall 10, which has a diameter that is significantly less than that of the wall 6 of the cylindrical portion 4 of the frame 2, is advantageously manufactured in the form of a hub and thus makes it possible to mount the rotor 1 on an axis, for example an axle in the represented preferred case of a wheel motor.

In the example shown a set of bolts 11 is also illustrated, which are arranged in a circle on the periphery of the closure portion 5 of the frame 2 and traverse it in order to allow the attachment onto the rotor 1 of the rim and the tire belonging to the wheel motor.

In order to produce the desired induction phenomenon, the rotor 1 further comprises a plurality of permanent magnets 12, which are assembled onto the cylindrical portion 4 of the frame 2 and mechanically fastened thereto on the inner surface 13 of the wall 6, in such a way as to be located, in the usage position, close to and facing the induction coils of the stator arranged within the receiving space 3.

Said permanent magnets 12 are arranged in rows 14, parallel to each other and oriented in the axial direction of the cylinder (a direction that is perpendicular to the rotational movement of the rotor 1).

The magnets 12 are preferentially flat and of a generally parallelepiped shape with reduced height and with substantially rectangular or square bases 15 constituting the magnetic poles of said magnets 12. A preferred example of a magnet 12 is represented in isolation in FIGS. 9 and 10.

Said magnets 12 comprise two lateral edges 16, which, when the magnets are assembled onto the rotor 1, are oriented as rows 14 according to the axial direction of the cylinder, and two frontal edges 17 which are placed transversely to the rows 14 according to a direction tangential to the movement of the rotor.

According to the invention, at the lateral edges 16 thereof, the permanent magnets 12 comprise an inward inclined surface 18, i.e., the thickness of the magnet decreases gradually from the base 15 intended to be supported against the wall 6 of the frame 2 towards the top of the inward inclined surface 18.

Although it is possible for said inward inclined surface 18 to continue along the entire height of the lateral edge 16 of the magnet 12, it is preferentially limited to a height of less than half of the overall height of the lateral edge 16 of the magnet 12, in order to increase the amount of magnet present and thus the total magnetization area.

For the same reasons, said inward inclined surface 18 is preferably extended by a vertical surface or an outwardly convex surface or preferably an outwardly inclined surface 19, conferring a generally concave shape to the lateral edge 16.

All of the permanent magnets 12 on the same row 14 are of the same polarity, i.e., they are arranged in such a way as to all have the base 15 of the same pole (North or South) on the same side. Thus they all have for example the North polarity bases thereof directed towards the wall 6 of the frame 2 and the South polarity bases thereof facing the stator, thus forming a so-called “South row” row, or vice versa to form a so-called “North row” row.

Said rows 14 are distributed into successive adjacent groups, each comprising one or more rows 14 of magnets 12 and within each of which all of the magnets 12 are of the same polarity. On the other hand, the polarity thereof is inverted alternately from one group to another, with the South groups and the North groups alternating successively over substantially the entire surface of the wall 6 of the frame 2.

Because of this arrangement, the magnets 12 tend to repel each other within the same row 14 and the same group, but to attract each other from one group to another.

The permanent magnets 12 can also be constituted of elements of a magnetizable material, which are assembled onto the frame 2 in the non-magnetized state, and are subsequently magnetized in order to become permanent magnets 12 such as described above. Assembly is thus facilitated insofar as the magnetization of said elements occurs only after the mounting thereof on the frame 2.

According to the invention, said permanent magnets 12 are directly fastened and in an entirely mechanical manner to the inner surface 13 of the wall 6 by means of a set of fastening strips 20 that extend in the axial direction of the cylindrical rotor 1 and are interspersed between each row 14 of permanent magnets 12. Each row 14 of permanent magnets 12 is thus advantageously bordered by two fastening strips 20, placed one on each side of the row 14 and the length thereof substantially corresponds to that of the row 14 of magnets 12.

These fastening strips 20 are preferentially manufactured from a non-magnetic material, for example non-magnetic stainless steel, in such a way as not to interfere with the magnetic field generated by the adjacent magnets 12.

In the case where they are not manufactured from a non-magnetic material, the height thereof is preferentially less than half of that of the permanent magnets 12 with which they are engaged. In this way, said fastening strips 20 do not reach the central plane between the two poles of the magnets 12, thus making it possible to avoid magnetic short-circuits between the magnets that will not participate in the generation of the required electromagnetic coupling.

The fastening strips 20 are mechanically fastened to the cylindrical portion 4 of the frame 2, preferably by means of a set of screws 21 that pass through the cylindrical wall 6 of the frame at a multitude of perforations 22, before engaging with threaded holes 23 of the fastening strips 20 with which they are engaged.

Said fastening strips 20 each comprise a base 24 intended to rest against the inner surface 13 of the wall 6 of the cylindrical portion 4 of the frame 2, extended by flaring at the lateral edges 25 thereof by two outwardly inclined sides 26.

The term “flaring”, used above, is understood to mean that the fastening strip gradually widens from the base 24 thereof, located at the frame 2 level, towards the upper part of the outwardly inclined sides 26.

Different forms can indifferently be adopted for the upper part of the fastening strips 20 depending upon the form chosen for the permanent magnets 12.

The strips can for example take the form of a trapezoidal cross-section, the outwardly inclined sides 26 being directly connected by a substantially flat upper plane.

The outwardly inclined sides 26 may also be extended, for example, by vertical, rounded or inward inclined flanges 27, before being connected by a preferably flat upper plane 28.

A fastening strip 20 with a hexagonal cross-section can thus be obtained according to a preferential embodiment of the invention. Such a fastening strip 20 is shown in isolation in FIGS. 7 and 8.

The advantage of the strip shown, in addition to those already revealed, is that hexagonal cross-section bars, of appropriate material and dimensions, exist commercially at inexpensive prices. In order to manufacture the fastening strips 20, it is therefore sufficient to cut these bars to length and to machine the threaded holes 23. Unlike the fastening strips described in prior art and mentioned in the introduction, the strips according to the invention are particularly economical.

Regardless of the form chosen for the cross-section thereof, the outwardly inclined sides 26 of the fastening strips 20 have a shape that is complementary to the inward inclined surfaces 18 of the permanent magnets 12. Thus, when the permanent magnets 12 are placed between two fastening strips 20, the inward inclined surfaces 18 of the magnets 12 engage with the outwardly inclined sides 26 of the fastening strips 20, which has the effect of opposing the lateral and vertical displacements of the magnets 12.

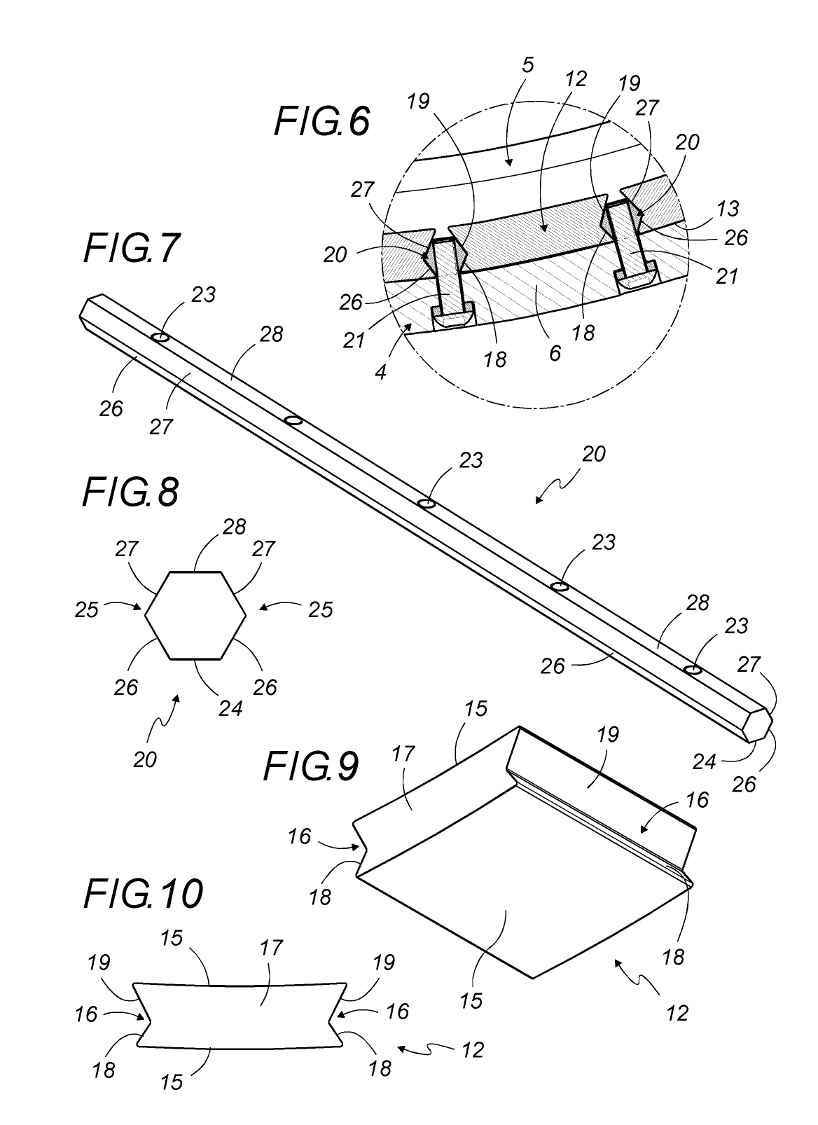

As can be seen more particularly in FIGS. 5 and 6, the fastening strips 20, by means of the specific geometric shape thereof, ensure the vertical (or radial) and lateral (i.e., in a direction that is tangential to the circular movement of the rotor) locking of the permanent magnets 12.

The longitudinal locking of the permanent magnets 12, i.e., in the axial direction of the cylinder, is ensured by means of mechanical stops 29 that prevent the movement of the permanent magnets 12 according to a direction parallel to the rows 14 of magnets.

In the exemplary embodiment shown, said mechanical stops 29 are constituted on each side by a flange 30 or a shoulder of the frame 2 against which the permanent magnets 12 abut when they are mounted on the cylindrical wall 6 and which apply pressure to the permanent magnets 12 which, because they are of the same polarity within each row 14, tend to repel.

According to other possible variants, said flanges 30 could be replaced on one side or on both sides by a wall of the frame or even by removable abutment parts.

Moreover, before or after the installation of the permanent magnets 12 on the frame 2, the rotor 1 can advantageously be impregnated with resin (not shown) to protect the metal parts it covers against corrosion.

In addition to making a direct and fully mechanical attachment of the permanent magnets 12, making it possible to completely do away with any problematic bonding, the fastening strips 20 according to the invention have yet another advantage over prior art devices.

Indeed, since they are in contact at the base 24 thereof with the wall 6 of the frame and extend between the rows 14 of magnets 12, entering with the upper face 28 thereof into the receiving space 3, they constitute a multitude of thermally conducting bridges which place the interior of the receiving space 3 in communication with the outside of the frame 2. The fastening strips 20 thus allow for better dispersion towards the outside of the heat generated inside the rotor 1, which lowers the internal operating temperature. They thus participate in the improvement of the overall performance of the rotor by reducing the operational heating thereof.

The invention also concerns a method for the fastening of permanent magnets 12 to a rotor 1 such as that described above.

Said method is implemented by virtue of the following steps:

The fastening strips 20 are arranged over the inner surface 13 of the wall 6 of the cylindrical portion 4 of the frame 2. To this end, they are placed parallel to each other and in the axial direction of the cylinder, spaced apart by a distance corresponding to the width of a row 14 of permanent magnets 12 or of magnetizable elements to be mounted.

Said fastening strips 20 are pre-assembled by means of mechanical attachment onto the frame 2, leaving a clearance between the fastening strips 20 and the frame 2. To this end, for example, the screws 21 are engaged through the perforations 22 of the wall 6 and into the threaded holes 23 of the fastening strips 20, but without completely tightening them.

Magnetizable elements 12 or permanent magnets are engaged between the fastening strips 20, by slightly raising the fastening strips 20 by virtue of the clearance existing between fastening strips 20 and the frame 2, and making them slide longitudinally until they abut against the flanges 30.

The permanent magnets 12, or magnetizable elements, then form parallel rows 14 of permanent magnets 12 or magnetizable elements, located between the fastening strips 20.

The mechanical fastening of the fastening strips 20 is completed on the frame 2, for example by tightening the screws 21, such as to eliminate the clearance existing between the fastening strips 20 and the frame 2. This causes the placing in contact and engagement of the inward inclined surfaces 18 of the permanent magnets 12, or magnetizable elements, with the outwardly inclined sides 26 of the adjacent fastening strips and leads to the vertically and laterally lock the permanent magnets 12 or magnetizable elements.

In the case of magnetizable elements, an additional step of magnetizing these magnetizable elements is performed such that they constitute permanent magnets 12 of the same polarity within each of the rows 14.

Obviously, the invention is not limited to the preferred embodiments described above and shown in the various figures, a person skilled in the art being able to make numerous modifications and imagine other embodiments without going beyond the framework and scope of the invention as defined by the claims.

1. A magnet bearing rotor for a synchronous rotating machine the rotor comprising: a cylindrical metal frame having an inner receiving space adapted to receive a fixed stator comprising a set of induction coils, a series of permanent magnets arranged in parallel rows oriented in an axial direction of the cylindrical metal frame, and a set of fastening strips, each of the fastening strips of the set of fastening strips placed longitudinally between two successive parallel rows of magnets of the series of permanent magnets and each of the fastening strips mechanically fastened to the cylindrical metal frame,
wherein
the cylindrical metal frame of the rotor comprises a one-piece structure comprising two portions manufactured as one piece: a cylindrical portion having a wall that supports the series of permanent magnets and the fastening strips of the set of fastening strips, and a closure portion forming a hub that closes a side of the cylindrical portion; and
wherein each of the fastening strips of the set of fastening strips provides a direct mechanical attachment for the series of permanent magnets on an inner surface of the wall of the cylindrical portion and each of the fastening strips of the set of fastening strips comprises a base that rests on the inner surface of the wall of the cylindrical portion and two outwardly inclined sides extending from the base; and
wherein each of the magnets of the series of permanent magnets comprises, at each lateral edges of each of the magnets, an inward inclined surface having a shape complementary to a shape of a corresponding one of the two outwardly inclined sides of an adjacent fastening strip, the inward inclined surface engaging the corresponding one of the two outwardly inclined sides of the adjacent fastening strip, wherein two of the set of fastening strips provide vertical and lateral locking of a permanent magnets positioned between the two fastening strips.

2. The rotor according to claim 1, wherein each of the fastening strips further comprises a vertical or an inward inclined flanges extending from each of the two outwardly inclined sides.

3. The rotor according to claim 1, wherein each of the fastening strips of the set of fastening strips has a cross-section of a hexagonal or trapezoidal shape.

4. The rotor according to claim 1, wherein each of the fastening strips of the set of fastening strips is non-magnetic or has a height less than half a height of each of the magnets in the series of permanent magnets.

5. The rotor according to claim 1, wherein each of the lateral edges of each of the magnets in the series of permanent magnets further comprises one of a vertical surface, an outwardly inclined surface, and an outwardly curved surface extending from the inward inclined surface.

6. The rotor according to claim 1, wherein the rotor further comprises mechanical stops which ensure longitudinal locking of each of the parallel rows of magnets of the series of permanent magnets.

7. The rotor according to claim 6, wherein the mechanical stops comprise one of flanges, shoulders, and walls of the frame.

8. The rotor according to claim 1, wherein the rotor further comprises a layer of anti-corrosion resin.

9. The rotor according to claim 1, wherein the rotor comprises a rotor of a traction motor.

10. A wheel motor comprising the rotor according to claim 1.

11. A method for fastening magnetizable elements or permanent magnets to a rotor, the rotor comprising a cylindrical metal frame having an inner receiving space adapted to receive a fixed stator having a set of induction coils, wherein the cylindrical metal frame comprises a one-piece structure having:
a cylindrical portion, and
a closure portion forming a hub that closes a side of the cylindrical portion,
the method comprising:
arranging fastening strips having outwardly inclined sides in parallel on an inner surface of the cylindrical portion the fastening strips oriented in an axial direction of the cylinder portion and spaced apart by a distance;
pre-assembling the fastening strips by mechanical attachment onto the frame leaving clearances between the fastening strips and the frame;
engaging magnetizable elements or permanent magnets having inward inclined surfaces between the fastening strips and sliding the magnetizable elements or permanent magnets longitudinally to form parallel rows of magnetizable elements or permanent magnets separated by pre-assembled fastening strips; and
tightening the mechanical attachment of the pre-assembled fastening strips to the frame to remove the clearances between the pre-assembled fastening strips and the frame to vertically and laterally lock the magnetizable elements or permanent magnets by engaging the inward inclined surfaces of the magnetizable elements or permanent magnet with the outwardly inclined sides of the fastening strips.

12. The rotor according to claim 6, wherein the mechanical stops comprise removable abutment parts.

13. The rotor according to claim 1, wherein the two outwardly inclined sides extend from the base by flaring from the base.

14. The rotor according to claim 13, wherein flaring from the base comprises the two outwardly inclined sides gradually widening from the base.

15. The rotor according to claim 14, wherein widening from the base comprises increasing a width of each of the fastening strips.

16. The method according to claim 11, wherein the method further comprises, when the method comprises magnetizable elements, magnetizing the magnetizable elements.

17. The method according to claim 11, wherein pre-assembling the fastening strips by mechanical attachment onto the frame comprises pre-assembling the fastener strips onto the frame with screws; and wherein tightening the mechanical attachment of the pre-assembled fastening strips to the frame comprises tightening the screws.
